(19) United States
(12) Patent Application Publication
(10) Pub. No.: US 2026/0135724 A1
(43) Pub. Date: May 14, 2026

(54) FAIL OPEN MECHANISM FOR N7 INTERFACE

(71) Applicant: T-MOBILE INNOVATIONS LLC, Overland Park, KS (US)

(72) Inventors: Narayanan Govindan KASI, Olathe, KS (US); Saravana Kumar VELUSAMY, Overland Park, KS (US)

(21) Appl. No.: 18/948,118

(22) Filed: Nov. 14, 2024

(51) Int. Cl. H04L 12/14; H04L 43/08; H04L 65/1069

(52) U.S. Cl. CPC H04L 12/1407; H04L 43/08; H04L 65/1069

(57) ABSTRACT

Systems and methods are provided for managing communication sessions for user equipment (UE) over a telecommunications network. Specifically, communication sessions can be established and maintained for the UE despite degradation in the N7 interface between a Policy Control Function (PCF) and a Session Management Function (SMF) in a 5G core network. Policy rules received from the PCF are stored locally at the SMF, allowing the SMF to manage sessions during periods of N7 interface degradation. In response to such degradation, the SMF can utilize the last received policy rule, apply session limits based on locally stored user-specific profile parameters, and report session metrics, such as session duration and data volume, to the Charging Function (CHF).

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for a fail open mechanism for an N7 interface of a 5G core network. More particularly, systems and methods enable a Session Management Function (SMF) to create one or more default profiles to be stored locally at the SMF for use when the N7 interface is experiencing a degradation or has experienced a failure.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary network environment in which implementations of the present disclosure may be employed, in accordance with aspects herein

FIG. 3 depicts a flow diagram of a method for managing an N7 interface, in accordance with aspects herein;

FIG. 4 depicts a flow diagram of a method for managing an N7 interface, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 22d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As used herein, a UE (also referenced herein as a user device) or WCD (wireless communication device) can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

In conventional cellular communications technology, a 5G telecommunications network comprises a 5G Core Network (5GC) and a Next Generation Node B (gNB). The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. At times, the network interfaces can experience complete failures, degradations, and the like. This compromises the ability of other NFs to obtain necessary data to establish or maintain reliable sessions for UEs.

The present disclosure relates to the efficient management of the N7 interface. The N7 interface enables communication between the Policy Control Function (PCF) and the Session Management Function (SMF). The PCF defines policies that regulate data usage, Quality of Service (QoS), and access control for user sessions. The SMF manages these sessions, handling their establishment, modification, and termination. The N7 interface acts as a communication bridge, allowing the PCF to transmit policy rules to the SMF, ensuring that user sessions align with the policies based on user subscriptions and network conditions.

Through the N7 interface, real-time policy decisions are transmitted from the PCF to the SMF. When a user initiates a data session, the SMF requests the relevant policy rules from the PCF over the N7 interface. These rules can govern data caps, QoS parameters, and charging information. The PCF dynamically provides this information, and the SMF enforces the rules throughout the session's lifecycle, ensuring that users receive services consistent with their subscription plans while the network efficiently allocates resources according to current conditions and demands.

The importance of the N7 interface lies in its role in maintaining policy consistency and adaptability across the 5G network. It ensures that user sessions are dynamically regulated according to changes in network conditions, such as congestion or user behavior. Additionally, it supports differentiated QoS, allowing high-priority services like video streaming or gaming to receive preferential treatment over standard traffic. This policy-driven management optimizes network resource utilization while delivering a seamless user experience.

In conventional systems, when communication between the PCF and SMF is interrupted—due to issues like transport link failures or core network instability—a fail-open mechanism is typically employed for the N7 interface. This mechanism allows the SMF to continue managing active user sessions even without receiving policy updates from the PCF. In such cases, the SMF uses the last known policy rules from the PCF, ensuring that users experience uninterrupted service. The primary goal of this fail-open mechanism is to maintain service continuity and avoid disruptions when real-time policy enforcement is temporarily unavailable. By relying on cached policy information, the SMF autonomously manages sessions, preventing sudden terminations or performance issues that could negatively impact the user experience, such as dropped calls or interrupted streaming.

However, while this approach serves its purpose of maintaining continuous service, it also introduces certain issues, especially in terms of policy enforcement. One key issue is the absence of real-time policy updates when the N7 interface is down. Under normal conditions, the PCF continuously monitors user activity and adjusts policies accordingly—such as enforcing data limits or throttling based on the user's subscription plan. However, when the SMF continues using outdated policy information during an N7 failure, this can lead to inconsistent policy enforcement. For instance, if a user has exceeded their data cap, the SMF may still allow the session to continue because it has not received the updated limit from the PCF. This discrepancy can result in unexpected data overages and additional charges for the user, leading to potential customer dissatisfaction.

The present disclosure introduces a dynamic fail-open mechanism that is configured to apply differentiated policies based on the user's subscription plan (e.g., prepaid or unlimited) when communication with the PCF is lost. This mechanism ensures service continuity while preventing excessive data usage for users with limited plans during the fail-open state. Upon losing communication, the SMF stores and applies the most recent policies from the PCF and may revert to default policies stored locally, if necessary. Furthermore, a fallback mechanism to a secondary PCF can be activated during prolonged fail-open periods. During such states, the SMF can also generate specific charging keys to ensure accurate billing and appropriate tracking of data usage.

In the event of a communication failure between the SMF and PCF, the fail-open mechanism is configured to enable the SMF to maintain user sessions using previously stored policy data, including information such as data caps and session time limits. Configurable parameters, such as retry attempts to re-establish communication with the PCF and time limits for remaining in the fail-open state, are also part of this mechanism. These safeguards help prevent unexpected data overages, particularly for prepaid customers, as the system enforces data limits even when the PCF is unreachable. Moreover, the fail-open mechanism includes a charging key feature that tracks data usage during both normal operation and fail-open periods, ensuring billing accuracy and fairness for all users.

Aspects of the present disclosure feature variable fail-open mechanisms based on subscription plans. For example, while a prepaid customer may have a strict data usage cap, a user with an unlimited plan may continue without restrictions. The PCF provides policy details, such as data limits and session timeouts, to the SMF based on each user's subscription. In a fail-open scenario, the SMF can apply these predefined limits even when it cannot actively communicate with the PCF, ensuring that users with limited plans do not exceed their allowances, while users on unlimited plans continue to receive service with minimal disruption.

When communication between the SMF and PCF fails, the fail-open mechanism can ensure that sessions continue using stored policy data, including data caps and session time limits. The system can also incorporate configurable parameters, such as retry attempts to re-establish communication and time limits for remaining in the fail-open state. This approach can aid in preventing unexpected billing issues, especially for prepaid users, by ensuring that the network adheres to the user's data plan even when the PCF is unreachable. In embodiments, the fail-open mechanism can further includes a charging key feature that tracks and distinguishes between normal and fail-open usage, allowing for accurate billing once the system returns to normal operation.

Accordingly, a first aspect of the present disclosure is directed to a method for managing a session between a UE and a cellular telecommunications network. The method comprises establishing, by a Session Management Function (SMF), a session with a Policy Control Function (PCF) over an N7 interface. The method also comprises receiving, by the SMF, a policy rule from the PCF associated with the UE, wherein the policy rule specifies conditions for managing the session. In response to a degradation with the PCF, the method comprises applying, by the SMF, the policy rule, wherein the policy rule comprises one or more of utilizing the last received policy rule for managing the session, determining a session limit based on user-specific profile parameters stored locally at the SMF, and reporting session metrics, including session duration and data volume, to a Charging Function (CHF) using a condition-specific charging key.

A second aspect of the present disclosure is directed to a system for managing a session between a UE and a cellular telecommunications network. The system comprises one or more processors; and one or more computer-readable media storing computer-usable instructions that, when executed by the one or more processors, cause the one or more processors to establish a session between a Session Management Function (SMF) and a Policy Control Function (PCF) over an N7 interface, and determine that the N7 interface between the SMF and the PCF is degraded. Based on the degraded N7 interface, the system can access one or more user-specific profile parameters stored locally at the SMF, and continue the session by applying a fail-open policy at the SMF, wherein the fail-open policy comprises one or more of utilizing the last received policy rule for managing the session, determining a session limit based on user-specific profile parameters stored at the SMF, and reporting session metrics, including a session duration and data volume, to a Charging Function (CHF) using a condition-specific charging key.

Another aspect of the present disclosure is directed to a method for managing policy rules during session degradation in a cellular telecommunications network. The method comprises monitoring for session changes, including one or more of IP address changes, location changes, transition between different network types, inactivity, network congestion, and quality of service (QoS) changes. The method also comprises detecting a degradation in communication between a Session Management Function (SMF) and a Policy Control Function (PCF), and applying a fail-open policy at the SMF based on the detected degradation, wherein the fail-open policy includes utilizing a cached policy rule.

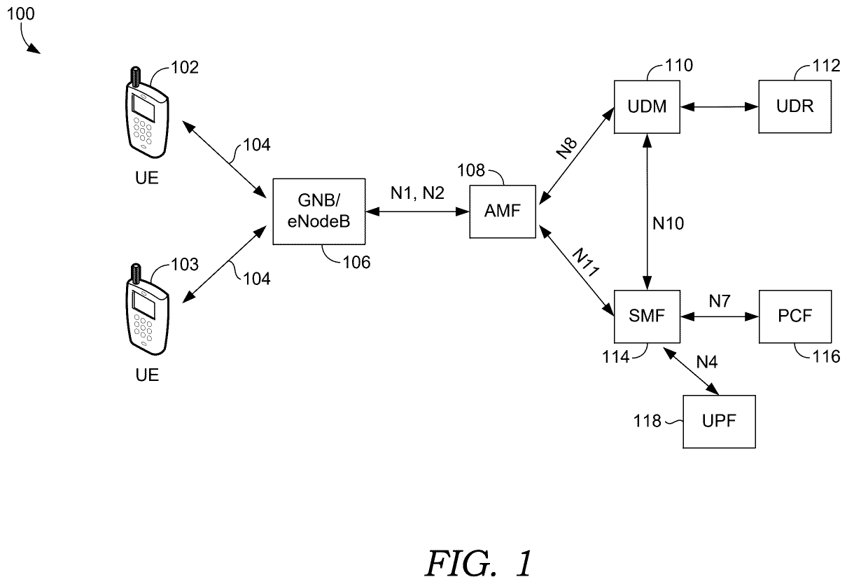

Turning to FIG. 1, a network environment suitable for use in implementing embodiments of the present disclosure is provided. Such a network environment is illustrated and designated generally as network environment 100. Network environment 100 is a simplified example of a suitable network environment and is not intended to suggest any limitation as to the scope of use or functionality of the disclosure. Neither should the network environment 100 be interpreted as having any dependency or requirement relating to any one or combination of components illustrated. Generally, the network environment 100 comprises one or more UEs, a radio access network (RAN) node, and a core network.

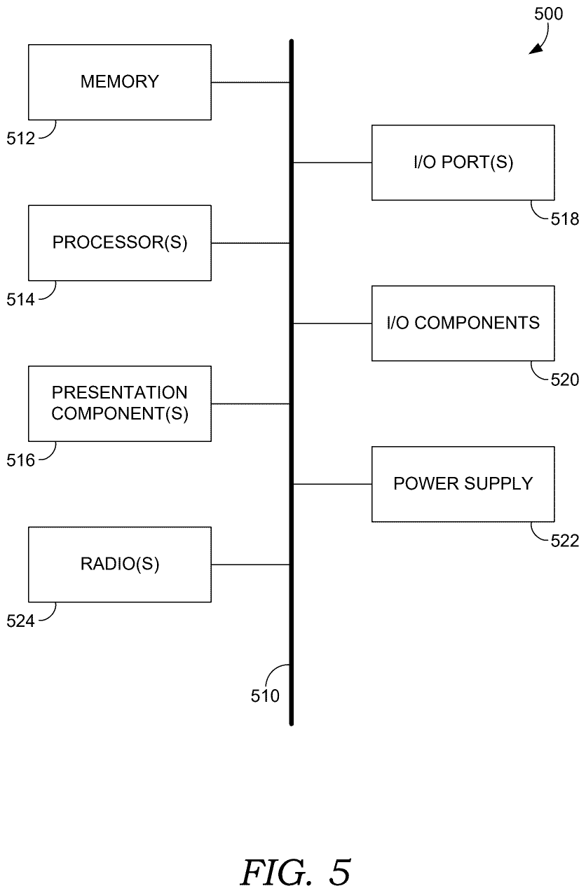

The network environment comprises at least one of a first UE 102 and a second UE 103, both of which have any one or more aspects of the computing device 500 of FIG. 5. In the network environment 100, UEs 102 and 103 may communicate with other devices, such as mobile devices, servers, etc. The first UE 102, correlating to a user with an unlimited plan, and the second UE 103, correlating to a user with a prepaid plan, may utilize the network environment 100 to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, a GNB/eNodeB 106 is associated with a network associated with a telecommunications provider that provides services to user devices, such as UEs 102 and 103. For example, the network may provide voice services to user devices or corresponding users that are registered or subscribed to utilize the services provided by a telecommunications provider.

The core network portion of the network environment 100 comprises a plurality of network functions, including an AMF 108, a UDM 110, a UDR 112, an SMF 114, a UPF 118, and a PCF 116, as well as several interfaces that connect the network functions. The N1 interface is a transparent interface from the UEs 102 and 103 to the AMF 108 that is used to transfer UE information to the AMF 108. The N2 interface connects the gNodeB 106 to the AMF 108. The AMF 108 handles connection and management mobility tasks. Essentially, the AMF 108 plays the role of the access point to the 5GC. The N8 interface is the interface between the AMF 108 and the UDM 110. It is used during the registration process when the AMF 108 needs user data from the UDM 110 for UE authentication purposes. The N11 interface is the interface between the AMF 108 and the SMF 114. The SMF 114 interacts with the AMF 108 to establish, manage, and terminate sessions. Essentially, when the UEs 102 and/or 103 request a new session, the UEs 102 and/or 103 and the gNodeB 106 use the N1 and N2 interfaces to carry messages to the AMF 108. The AMF 108 takes care of connection and mobility management and then passes the request on to the SMF 114 via the N11 interface.

The UDM 110 is responsible for obtaining subscriber data that the SMF 114 accesses for managing user sessions on the network. Communications between the UDM 110 and the SMF 114, including requests from the SMF 114 to the UDM 110 and responses from the UDM 110 to the SMF 114, utilize the N10 interface. The UDM 110 can obtain subscriber data requested by the SMF 114 from a Unified Data Repository (UDR) 112 that stores the user information. While only one UDR is shown for simplicity in FIG. 1, it should be understood that the UDM 110 can be associated with more than one UDR.

The SMF 114 communicates with the Policy Control Function (PCF) 116 via the N7 interface to manage session-related policies. The PCF 116 is responsible for defining policies related to data usage, Quality of Service (QoS), and access control, which are then enforced by the SMF 114 during user sessions. The N7 interface is crucial as it allows the PCF 116 to transmit these policy rules to the SMF 114, ensuring that the sessions for UE 102 and UE 103 adhere to the policies defined by the network operator. Additionally, SMF 114 interacts with the User Plane Function (UPF) 118 via the N4 interface, managing data flow and ensuring proper QoS delivery.

In the case of UE 102 (i.e., unlimited plan), the SMF 114 receives policy rules that provide more lenient session limits, allowing UE 102 to continue using the network without restrictions on data volume or session duration. On the other hand, UE 103 (i.e., prepaid plan) is subject to stricter policies, such as data caps and limited session durations, based on the user's subscription plan. The N7 interface ensures that these differentiated policies are applied, allowing the network to manage resources efficiently while adhering to the service-level agreements of each user plan.

When communication between SMF 114 and PCF 116 via the N7 interface degrades or fails, the SMF 114 activates a fail-open mechanism. This mechanism allows the SMF 114 to manage ongoing sessions for both UE 102 and UE 103 using cached policy rules or user-specific profile parameters stored locally at the SMF 114. The fail-open mechanism ensures that service is not interrupted for either UE 102 or UE 103, even when real-time policy updates are unavailable. For UE 102, the SMF 114 may apply lenient policies, continuing service without data restrictions. For UE 103, however, the SMF 114 may enforce data limits and session timeouts based on the last known policy rules received from PCF 116, preventing overages or excessive usage during the fail-open state.

In aspects, the fail-open mechanism may also allow the SMF 114 to attempt re-establishing communication with PCF 116 through retry mechanisms. If communication cannot be restored within a predefined retry threshold, the SMF 114 may continue to apply the cached policies, ensuring that sessions for UE 102 and UE 103 continue without disruption. In additional embodiments, the system may dynamically adjust its retry logic to avoid excessive retries that might exacerbate network congestion or further delay policy updates. In various aspects, the SMF 114 may also switch to default policies stored locally in cases of prolonged communication failure. These fallback policies ensure that users with prepaid plans, like UE 103, do not exceed their data allowances, while users with unlimited plans, like UE 102, can continue using the network with minimal disruptions.

In situations where the N7 interface is restored after a period of degradation, the SMF 114 may resume communication with PCF 116, updating the policies as needed to reflect real-time network conditions. The SMF 114 can transmit session statistics, including data usage and session duration during the fail-open period, back to PCF 116 and CHF to ensure accurate billing and policy enforcement. This ensures that discrepancies in policy enforcement during fail-open periods are resolved once communication is restored, and users such as UE 103 are appropriately charged for any additional usage.

In embodiments, the fail-open mechanism enables the SMF 114 to continue sessions when the N7 interface is degraded, ensuring uninterrupted service for both UE 102 (i.e., unlimited plan) and UE 103 (i.e., prepaid plan). By applying stored policy rules and retrying communication with the PCF 116 as needed, the SMF 114 can minimize service disruption and ensure accurate session management. In various embodiments, the SMF 114 can also generate unique charging keys during fail-open periods, allowing the network to distinguish between normal operation and fail-open usage for accurate billing and reporting once communication is restored.

When a network function, such as the SMF 114, does not receive a reply to a query to the PCF 116 over the N7 interface, it is typically configured to continue retrying the query. Thus, conventionally, the PCF 116 continues to receive repeated queries for the same request, which may contribute to increased signal noise at the PCF 116. In other circumstances, repeated requests from the SMF 114 may never reach the PCF 116 because the N7 interface is disrupted, resulting in the SMF 114 not receiving a response. A reply may remain outstanding for an extended period, indicating that the SMF 114 cannot receive the necessary policy data to manage a session for UE 102 or UE 103, and the corresponding reply is communicated to the user devices.

Rather than failing to initiate or manage a session for UE 102 or UE 103, the present disclosure introduces a fail-open mechanism when the N7 interface is seemingly non-operational (e.g., the interface has been severed, failed, or the PCF 116 is experiencing congestion or degradation). In such instances, the SMF 114 can be configured with a retry instruction that includes a predetermined retry threshold with a maximum number of retry attempts. For example, the SMF 114 may be configured to retry the PCF 116 a maximum of two times, or any configurable number of times, when it does not receive a response. This will help alleviate signal noise caused by repetitive queries. When the predetermined retry threshold is reached (i.e., the maximum number of retry attempts have been exhausted), and no reply is received over the N7 interface, the SMF 114 is triggered to initiate the fail-open mechanism.

In embodiments, the fail-open mechanism may include the creation and storage of a default profile (or a plurality of default profiles) locally at the SMF 114. The creation and storage of a default profile can be triggered in several ways. For instance, the system may detect degradation in the N7 interface. “Degradation,” as used herein, refers to a decrease in performance compared to expected metrics, which can be based on historical data or configurable thresholds. Degradation may result from congestion on the N7 interface. In such cases, even before complete failure, the SMF 114 may retrieve profile data from the PCF 116 and create a locally stored version of the profile for future use, should the degradation progress to a complete failure of the N7 interface.

Degradation thresholds can be employed to trigger the fail-open mechanism and guide the SMF 114 in efficient session management. A first predetermined threshold of degradation may trigger the SMF 114 to fetch the user profile from the PCF 116 while communication is still possible. This degradation threshold serves as a signal to the SMF 114 to create and store a local version of the user profile. In embodiments, a second predetermined degradation threshold may trigger the SMF 114 to use the locally stored profile for future session management, without making additional requests to the PCF 116. In aspects, the fail-open mechanism can remain active for a configurable duration or based on a certain number of session requests. For example, when UE 102 (i.e., unlimited plan) or UE 103 (i.e., prepaid plan) initiates a session using the locally stored profile at SMF 114, the session can be managed based on the cached profile until the session is terminated. Session termination may occur when the user deactivates their device, enables airplane mode, and/or the session is idle for a prolonged period, such as 24 hours.

In another embodiment, degradation or failure of the N7 interface could occur suddenly (e.g., physical disruption such as a cut fiber optic cable). In such cases, the N7 interface becomes completely non-functional, and the SMF 114 must rely on a previously stored profile. If the degradation was gradual, the SMF 114 may have already created the local profile based on the degradation thresholds described earlier. If the degradation was sudden, the SMF 114 may use a previously stored profile, assuming it has been created within a predetermined time window. In certain embodiments, the SMF 114 may be configured to update the locally stored profiles at regular intervals, such as daily or twice per day, to ensure they remain current.

This approach allows the SMF 114 to continue managing sessions for UE 102 and UE 103 using the locally stored profile, reducing the impact of the N7 interface failure. By creating locally stored profiles and reducing repeated queries to the PCF 116, the SMF 114 can operate efficiently during the N7 interface failure. Meanwhile, the network can perform dead-peer detection to identify when the N7 interface to the PCF 116 is restored.

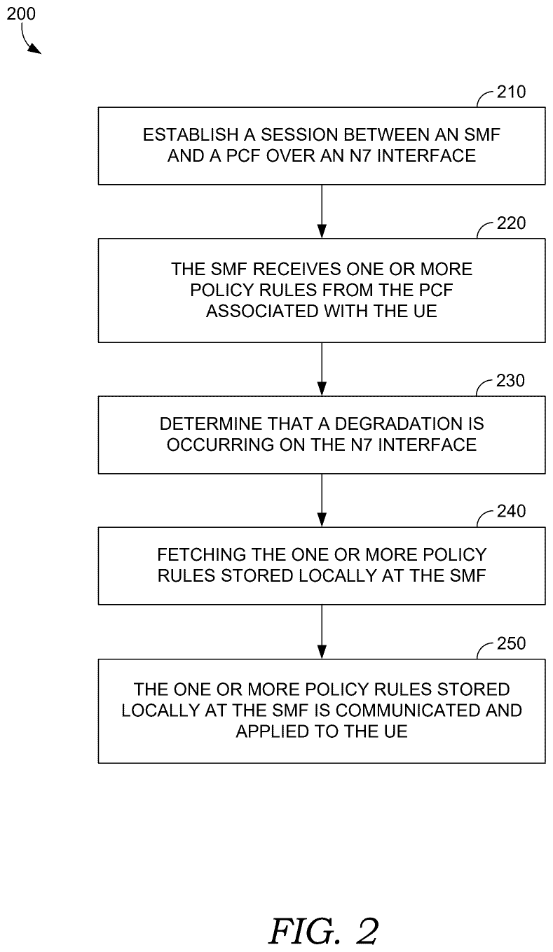

Turning to FIG. 2, a flow diagram 200 is provided illustrating a flow to manage N7 interfaces. Initially, at block 210, a session is established between an SMF and a PCF over an N7 interface. At block 220, the SMF receives one or more policy rules from the PCF associated with the UE. At block 230, it is determined that a degradation is occurring on the N7 interface. A degradation is occurring may be determined utilizing degradation thresholds as described herein. Upon determining that a degradation is occurring, fetching the one or more policy rules stored locally at the SMF at block 240. The one or more policy rules stored locally at the SMF is communicated and applied to one or more components of the cellular core network to establish a first session for the UE at block 250.

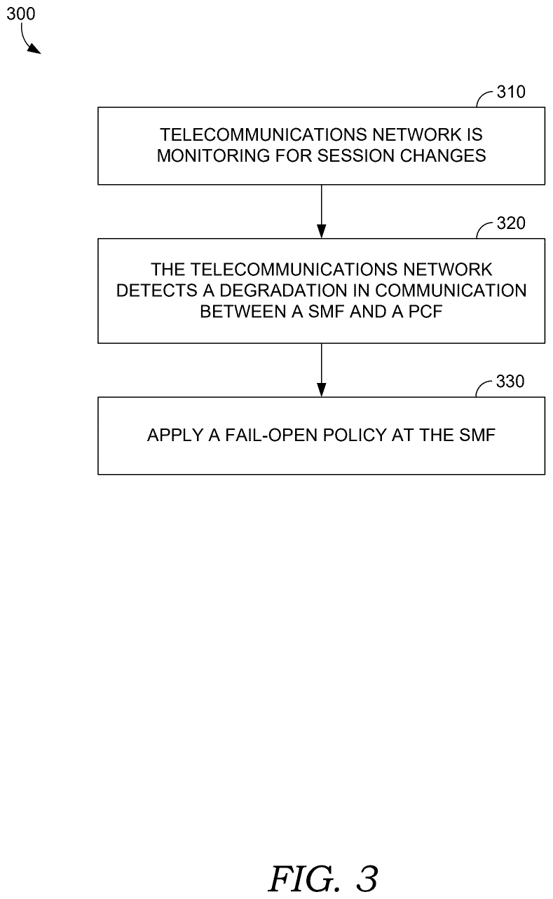

In FIG. 3, a flow diagram 300 is provided depicting a flow to manage policy rules at N7 interfaces. Initially, at block 310, the telecommunications network is monitoring for session changes. These session changes can include one or more of IP address changes, location changes, transition between different network types, inactivity, network congestion, and quality of service (QoS) changes. At block 320, the telecommunications network detects a degradation in communication between a SMF and a PCF. Based on a determination that the N7 interface is degraded, a fail open policy at the SMF is applied at block 330. The fail open policy includes utilizing a cached policy rule that is stored at the SMF.

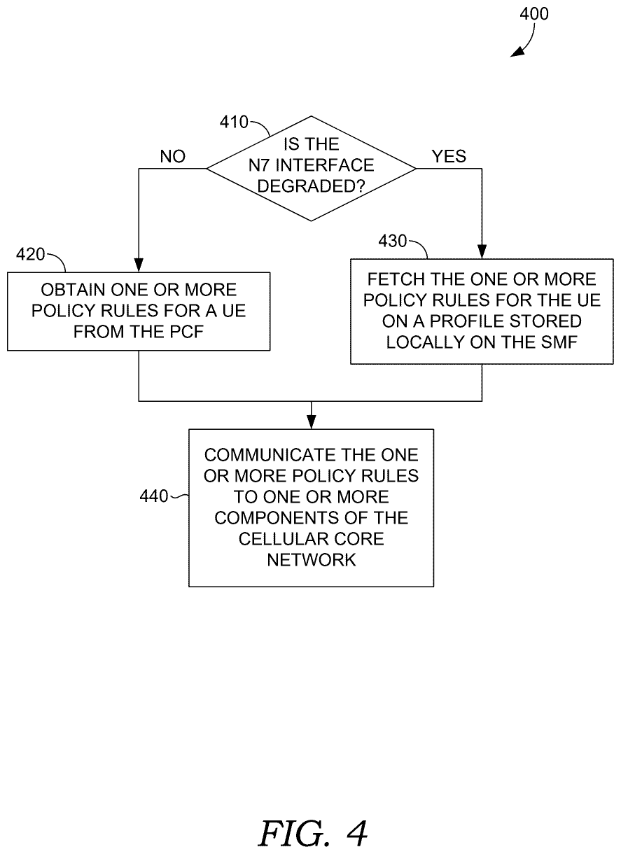

In FIG. 4, a flow diagram 400 is provided depicting a flow to manage N7 interfaces. Initially, at block 410, a decision is made whether an N7 interface is degraded. Based on a determination that an N7 interface between a SMF and a PCF is not degraded, one or more policy rules for a UE is obtained from the PCF at block 420. Based on a determination that the N7 interface is degraded, the one or more policy rules for the UE are fetched from a profile stored locally on the SMF at block 430. The one or more policy rules is communicated to one or more components of the cellular core network at block 440.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for managing a session between a user equipment (UE) and a cellular telecommunications network, the method comprising:
establishing, by a Session Management Function (SMF), a session with a Policy Control Function (PCF) over an N7 interface;
receiving, by the SMF, a policy rule from the PCF associated with the UE, wherein the policy rules specify conditions for managing the session;
in response to a degradation with the PCF, applying, by the SMF, the policy rule, wherein the policy rule comprises one or more of:
utilizing a last received policy rule for managing the session;
determining a session limit based on user-specific profile parameters stored locally at the SMF; and
reporting session metrics, including session duration and data volume, to a Charging Function (CHF) using a condition-specific charging key.

2. The method of claim 1, wherein the policy rule further comprises terminating the session after one or more of a predetermined data volume limit or a predetermined time limit reaches a threshold, and attempting to re-establish a new session with updated policies from the PCF.

3. The method of claim 1, wherein the CHF is further configured to apply specific billing rates based on the condition-specific charging key received from the SMF during the degradation.

4. The method of claim 1, wherein the policy rule is implemented to prioritize emergency services if the session corresponds to an emergency communication.

5. The method of claim 1, further comprising differentiating between user plans to apply different policy rules, wherein the user plans include prepaid and unlimited plans.

6. The method of claim 1, wherein the last received policy rule received from the PCF includes information about maximum bit rates and charging for the session.

7. A system for managing a session between a user equipment (UE) and a cellular telecommunications network, the system comprising:
one or more processors; and
one or more computer-readable media storing computer-usable instructions that, when executed by the one or more processors, cause the one or more processors to:
establish a session between a Session Management function (SMF) and a Policy Control Function (PCF) over an N7 interface;
determine that the N7 interface between the SMF and the PCF is degraded;
based on the degraded N7 interface, access one or more user-specific profile parameters stored locally at the SMF; and
continue the session by applying a fail-open policy at the SMF, wherein the fail-open policy comprises one or more of:
utilizing a last received policy rule for managing the session;
determining a session limit based on user-specific profile parameters stored at the SMF; and
reporting session metrics, including a session duration and a data volume, to a Charging Function (CHF) using a condition-specific charging key.

8. The system of claim 7, wherein the one or more user-specific profile parameters include at least one of an allocated data volume limit or a time limit for the session.

9. The system of claim 7, wherein the one or more computer-usable instructions further cause the one or more processors to monitor for triggers indicating changes in the session, the triggers including at least one of a change in IP address, a location change, a transition between different network types, a period of inactivity, network congestion conditions, or quality of service (QoS) changes.

10. The system of claim 9, wherein the fail-open policy is applied in response to a communication failure between the SMF and the PCF triggered by detected changes in the session.

11. The system of claim 9, wherein the degradation of the N7 interface is caused by one or more conditions, including:
congestion above a congestion threshold identified at the PCF; or
a failure at the N7 interface.

12. The system of claim 7, wherein the last received policy rule received from the PCF includes information about maximum bit rates and charging for the session.

13. The system of claim 8, wherein the one or more computer-usable instructions further cause the one or more processors to report, to the CHF, the data volume consumed during a fail-open period using the condition-specific charging key associated with the fail-open policy.

14. The system of claim 8, wherein the SMF is configured to locally cache policy rules received from the PCF to facilitate continued session management during interface degradation.

15. A method for managing policy rules during session degradation in a cellular telecommunications network, the method comprising:
monitoring for session changes, including one or more of IP address changes, location changes, transition between different network types, inactivity, network congestion, and quality of service (QoS) changes;
detecting a degradation in communication between a Session Management Function (SMF) and a Policy Control Function (PCF); and
applying a fail-open policy at the SMF based on the detected degradation, wherein the fail-open policy includes utilizing a cached policy rule.

16. The method of claim 15, further comprising attempting to re-establish communication with the PCF after detecting degradation in the N7 interface.

17. The method of claim 15, wherein a fallback mechanism to a secondary PCF is applied when the primary PCF is not reachable after a predefined time period.

18. The method of claim 15, further comprising providing a notification to the PCF upon successful re-establishment of communication, including session statistics and conditions during a fail-open period.

19. The method of claim 15, further comprising dynamically generating a condition-specific charging key during the fail-open period based on session context.

20. The method of claim 15, wherein the SMF is configured to update user-specific information based on periodic reports from the PCF when communication is re-established.
